(19) United States
(12) Patent Application Publication
(10) Pub. No.: US 2007/0005618 A1
(43) Pub. Date: Jan. 4, 2007

(54) Systems and methods for modeling business processes

(76) Inventors: Konstantin Ivanov, Saarbruecken (DE); Dagmar Emma Anneliese Reul, St. Ingbert (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/447,790

(22) Filed: Jun. 7, 2006

Related U.S. Application Data
(60) Provisional application No. 60/687,847, filed on Jun. 7, 2005.

(51) Int. Cl. G06F 7/00

(52) U.S. Cl. 707/100

(57) ABSTRACT

Methods and systems are provided for modeling business information and providing navigation between business information models. An exemplary method for modeling business information uses integrated model data, and includes the steps of storing a first business information model and second business information model written in description notations, and assigning the second business information model to an object, wherein the object is represented by a symbol in the first business information model. An exemplary method for providing navigation between business information models includes displaying a graphical representation of an object in a first business information model, and providing an interface for navigating to display a second business information model, where the step of providing the interface includes providing the interface with the graphical representation of the object.

### CROSS REFERENCE TO RELATED APPLICATION(S)

This application claims the benefit of priority from U.S. Provisional Application No. 60/687,847, entitled “Computerized Systems and Methods for Modeling and Executing Business Processes,” filed Jun. 7, 2005, the disclosure of which is expressly incorporated herein by reference to its entirety.

### BACKGROUND

I. Technical Field

The present invention generally relates to the fields of computer graphics and software-based modeling tools. More particularly, and without limitation, the invention relates to systems and methods for modeling business information such as business or technical processes.

II. Background Information

Business processes are the driving factors of a successful company. On the operational level, business processes are a description of consecutive functions or activities in order to create added value. Business processes may relate to various activities of a company, such as the handling of purchase orders or product returns. Business processes can also be used to describe the interaction between various types of business information, such as the organization of a business, data used by a business, functions that describe the operation of a business, and products or services offered by a business.

Successful companies often design their processes with the help of modeling tools. Modeling tools can depict, analyze and optimize the development of a business process, and can be used with other types of business information as well. A “modeling tool” may include software and/or other computerized systems that can be used to plan a business process or other business information, and can be used to model all or part of a business process or other aspects of a business. By way of example, a modeling tool can be used to generate descriptions of business information in a “description notation.” A description notation can be a format for written or executable computer code, such as WSDL (Web Services Description notation) or BPEL (Business Execution Language for Web Services), or a description notation can be a formalized way of graphically illustrating concepts, such as EPC (event-driven process chain) or VAC (value-added chain diagram).

Modeling tools are commercially available from various vendors. For example, the ARIS Platform of IDS Scheer AG (Saarbruecken, Germany) has been a market leader for Business Process Modeling tools. ARIS provides several description notations proven in practice to enable businesses to optimize their strategy and processes. By providing description notations well suited for modeling different facets of a business, ARIS enables business information to be modeled at varying levels of detail, and from different perspectives or “views.”

The description notations used by ARIS are structured into five (5) views to present an organized description of business information. These views include: (i) Organization: description of the organizational structure; (ii) Data: description of the business data structure; (iii) Functions: description of the business tasks regarding the hierarchical structure; number and structure of applications supporting the execution of the business tasks; (iv) Product/Services: description of products and services produced by the company; and (v) Processes (or control): description of the interaction of elements originated from the four (4) views mentioned above. In addition, each view can be partitioned into different levels, known as a view hierarchy. For example, the view hierarchy for the process/control view is known as the process hierarchy: requirements definition; design specification; and implementation description. View hierarchies can be defined for each view, and can be supplemented or modified if the user so desires.

Each of the five views ARIS defines for business information can be modeled using description notations provided by ARIS, and different description notations can be used for different levels within a view. Thus, a “business information model” can be created for the process view, and called a “business process model.” Similarly, for a data view, a “business data model” could be created, and for an organization view, a “business organization model” could be created. Each business information model can provide information relevant to one or more levels of the view hierarchy for the view with which it is relates, i.e. business data models provide information about levels of the data hierarchy. Models at different levels can be used to provide various degrees of refinement at different layers of a view hierarchy. As an example, the process view, also known as the control view, can be modeled differently at the requirements definition, design specification, and implementation description levels, with each of the levels providing different degrees of refinement about processes that occur within the business.

The requirements definition level describes the business problem in a user-friendly way, but also serves as a formal description that can be starting point for a consistent transformation into an information technology (IT) implementation. Typically, ARIS users will generate VAC diagrams for the most basic explanation at the requirements level, and use EPC diagrams to describe in more detail the requirements for steps in the VAC diagrams.

A VAC diagram specifies the functions in a company which directly influence the real added value of the company. These functions can be linked to one another in the form of a sequence of functions and thus form a value-added chain. In a value-added chain diagram, functions can be arranged in a hierarchy similar to illustrate relationships between the functions. A first function can be subordinate to a second function, i.e., a sub-function within the second function, or superior to the second function, i.e., the second function is subordinate to the first function.

A VAC diagram can also illustrate the links between functions and organizational units and functions and information objects. The allocation of organizational units to functions can differentiate, as in process chains, between, for example, technical responsibility, IT responsibility and the execution of a function. The VAC is thus used to describe the aggregated view of the processes of the enterprise. VACs may be thought of as conceptual models, appropriate for business modeling of processes or other views of a business.

An EPC model is an ordered graphical representation of events and functions. Further, an EPC model provides connectors that allow alternative and parallel execution of processes. For example, EPC models may include logical operators, such as OR, AND, and XOR that describe relationships between elements of the process. An “element” may refer to one step or activity, for example. Additionally, in an EPC model, logical relationships between elements are termed a “control flow.” However, an EPC model, while graphical, does not actually implement a business process. It is merely a schematic representation of a business process.

Using EPCs, the procedural organization of the company can be defined. Links between concepts within the data, function and organizational view can be used to represent various business processes. The EPC can thus be used to describe the details of functions or activities within a business process. EPCs can be thought of as logical models, appropriate generally for modeling business processes or other views of a business.

The design specification level is used to transfer the terms from the requirements definition level into categories suitable for realization by information technology. If the EPC from the requirements definition level has functionality which is amenable to being implemented by web services, it can be advantageous to create a model that is tied to Business Process Execution Language code (BPEL). BPEL is an XML-based standard language for task-sharing via Web services in multi-computer environments. Because BPEL provides a standardized interface for web services, it can be used across both computer platforms and organizational entities. BPEL can be thought of as providing for technical modeling.

However, the BPEL standard does not define a graphical means of representing BPEL code. As a result, BPEL itself is not ideal for design specification modeling by non-technical personnel. Instead, ARIS provides a graphical description notation for the representation of BPEL processes in a BPEL Process Model (BPM) and BPEL Allocation diagrams (BPADs). Using this notation, BPEL code can be represented abstractly in a BPM, and elements within the BPM can be described in more detail by using BPADs. In this way, a user can formally describe technical aspects of a business process, in a graphical description notation as BPMs and BPADs. BPEL-compliant XML code can automatically be generated from BPMs and BPADs, so that web services can be invoked to implement various steps in the business process. ARIS users can also use UML as a description notation to model processes at the design specification level. In either case, the design specification description can remain independent of the implementation of functionality described in the model.

The implementation description level is where a design specification description is adapted to the specific environment in which it is intended to operate. For example, a description at the design specification level could call for invoking a web service, whereas the implementation description level would include information about the details of the web service, such as where it is located, what physical architecture it runs on, and what software platforms will be used to implement the web service.

In short, process description usually starts on requirements definition level. Based on the requirements, the blueprint for the IT implementation is typically worked out in the design specification step. Then, at the implementation description step, the description of the real implementation will be derived from the blueprint.

As described above, particular description notations are generally used for modeling at particular layers of a view hierarchy, each view hierarchy describing layers of a different type of business information. For example, in the process hierarchy users typically will model the requirements definition layer using VAC's and EPC's. However, ARIS allows users to flexibly choose description notations as they wish to model different layers. For example, while EPC's are typically used to model the requirements definition layer, users may choose to use EPC's to model the design specification layer as well.

Using multiple description notations as described above allows users to have appropriate options available for modeling business information through different views, at different levels of view hierarchies. However, multiple tools are generally required to create and maintain separate data repositories for the different description notation, such as VADs, EPCs, BPMs and BPADs, BPEL itself, and UML. This poses several problems. First, from a user's perspective, several tools are needed to view different layers of the business process description, e.g., between the EPC and the BPM, and there is no easy way to navigate between concepts in the EPC and the BPM. Second, as models are created and modified with one toolset in a repository for one level, updates may be necessary at other levels of description. Thus, there is some likelihood the data in the two repositories will become inconsistent as changes are made to one repository, and either not applied or incorrectly applied to the other repository.

Therefore, it is desirable to provide an integrated toolset for introducing, using, and maintaining business information models at varying layers of a business view hierarchy, using description notations appropriate for the level and view being modeled. It is further desirable to provide an implementation of a repository that maintains consistency between business information models written in appropriate description notations.

### SUMMARY

Consistent with the invention, there is provided systems and methods for modeling business information with integrated model data, by storing a first business information model, the first business information model being written in a first description notation; storing a second business information model, the second business information model being written in a second description notation, the second description notation not necessarily being different from the first description notation; and assigning the second business information model to an object, the object being represented by a symbol in the first business information model, wherein at least one of the first description notation and the second description notation is an execution language description notation.

Additionally consistent with the invention, there is provided systems and methods for modeling business information with integrated model data by storing a first business information model, the first business information model being written in a first description notation; storing a second business information model, the second business information model being written in a second description notation, the second description notation not necessarily being different from the first description notation; and storing occurrence information for the object, indicating that the object is represented by both a symbol in the first business information model and a symbol in the second business information model, wherein at least one of the first description notation and the second description notation is an execution language description notation.

Additionally consistent with the invention, there is provided systems and methods for providing navigation between business information models, comprising the steps of displaying a graphical representation of an object in a first business information model, the first business information model being written in a first description notation; and providing an interface for navigating to display a second business information model, the second model being written in a second description notation, the second description notation not necessarily being different than the first description notation; wherein the step of providing an interface includes providing the interface with the graphical representation of the object, and further wherein at least one of the first description notation and the second description notation is an execution language description notation.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the present invention and, together with the description, help explain some of the principles associated with the invention. In the drawings,

FIG. 1 illustrates a block diagram of an exemplary modeling system, consistent with an embodiment of the invention;

FIGS. 2A-2E illustrate exemplary ARIS EPC symbols that can be used in models, consistent with an embodiment of the invention;

FIG. 3 illustrates exemplary ARIS BPEL symbols that can be used in models, consistent with an embodiment of the invention;

FIG. 4 is a flowchart of an exemplary method, consistent with an embodiment of the invention;

FIG. 5A illustrates an exemplary value-added chain diagram, consistent with an embodiment of the invention;

FIG. 5B illustrates exemplary objects and models that may be stored in a computer, consistent with an embodiment the invention;

FIG. 6A illustrates a portion of an exemplary EPC model, consistent with an embodiment of the invention;

FIG. 6B illustrates an exemplary BPEL process model, consistent with an embodiment of the invention;

FIG. 7 illustrates an exemplary UML component diagram, consistent with an embodiment of the invention;

FIG. 8 is a flowchart of an exemplary method, consistent with an embodiment of the invention;

FIG. 9 illustrates an exemplary BPEL allocation diagram, consistent with an embodiment of the invention;

FIG. 10 is a flowchart of an exemplary method, consistent with an embodiment of the invention;

FIG. 11A illustrates an exemplary value-added chain diagram, consistent with an embodiment of the invention;

FIG. 11B illustrates another exemplary value-added chain diagram, consistent with an embodiment of the invention; and

FIG. 12 illustrates an exemplary BPEL process model, consistent with an embodiment of the invention.

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

The object of the invention is to provide an integrated toolset for introducing, using, and maintaining business information models, using a repository that maintains consistency between models written in appropriate description notations. A further object is to provide for navigation between different levels of a view hierarchy, by navigating between models written in languages appropriate for a particular level of the view hierarchy. The data in the repository is generally maintained according to a single meta-model.

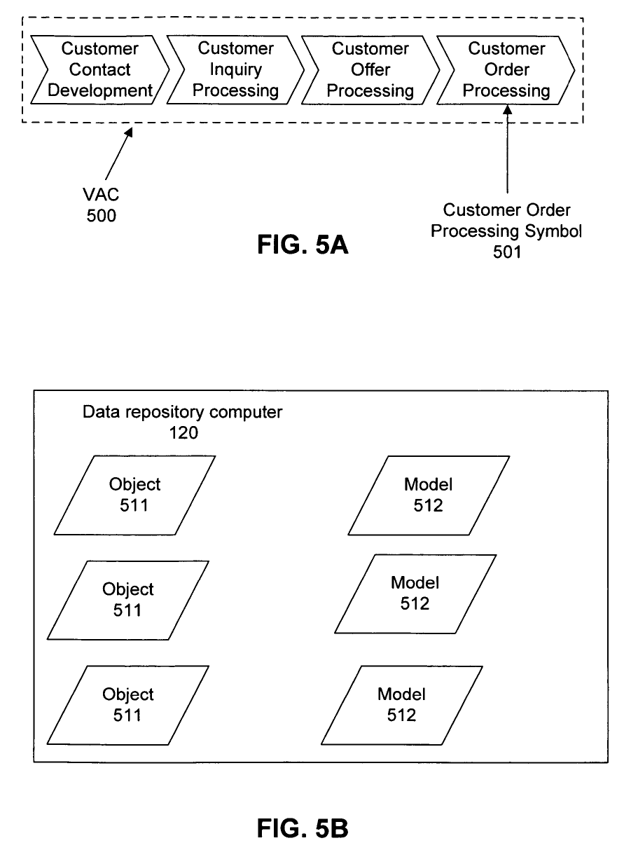

As used herein, “business information” means information relevant to a business. As discussed above, business information can be organized as business data, business organization, business processes, business functions, and business products and services. Other ways of organizing business information are also possible. One example of business information is the business concepts that are modeled by VAC 500 as shown in FIG. 5A. Other models described herein model concepts which are also business information.

“Integrated model data” generally refers to any data relevant to business information that a user wishes to model. Integrated model data is data consistent with conventions defined by the meta-model. Examples of integrated model data include objects, symbols, models, relationships, and assignments, including objects 511 shown on data repository computer 120 in FIG. 5B, and VAC 500.

A “first business information model” is a description, in a description notation, of business information. If the business information, for example, relates to business processes, the model can be termed a “business process model.” A “second business information model” is like the first business information model, it can be in existence before the creation of the first business model, created in concurrence with the first business information model, or created after the first business information model. A first business information model need not necessarily have any relevance to a second business information model. For example, VAC 500 could be either a first business information model or a second information model, as could the other models described herein.

A “first description notation” means any graphical or written way of describing business information. Examples include EPC notation, VAC notation, BPEL graphical symbols, XML, BPEL-compliant XML, and UML component diagram notation. A “second description notation” may also comprise any graphical or written way of describing business information, and can have any or no similarity to the first description notation.

An “object” is a data structure, and can be suitable for storage on a computer-readable medium. Objects can be stored in many different manners, including structures, classes, linked lists, arrays, elementary data types such as integer or character, etc. Object types can be defined, and data structures consistent with the type definitions can be used in a manner defined by the meta-model. Object types relate to concepts that are relevant to business information modeling. Examples include objects 511 stored on data repository computer 120.

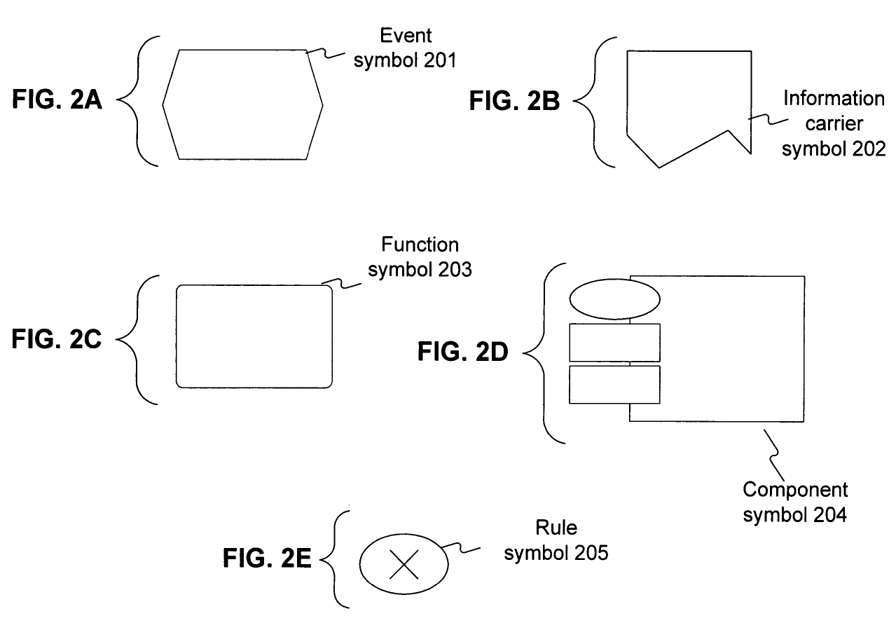

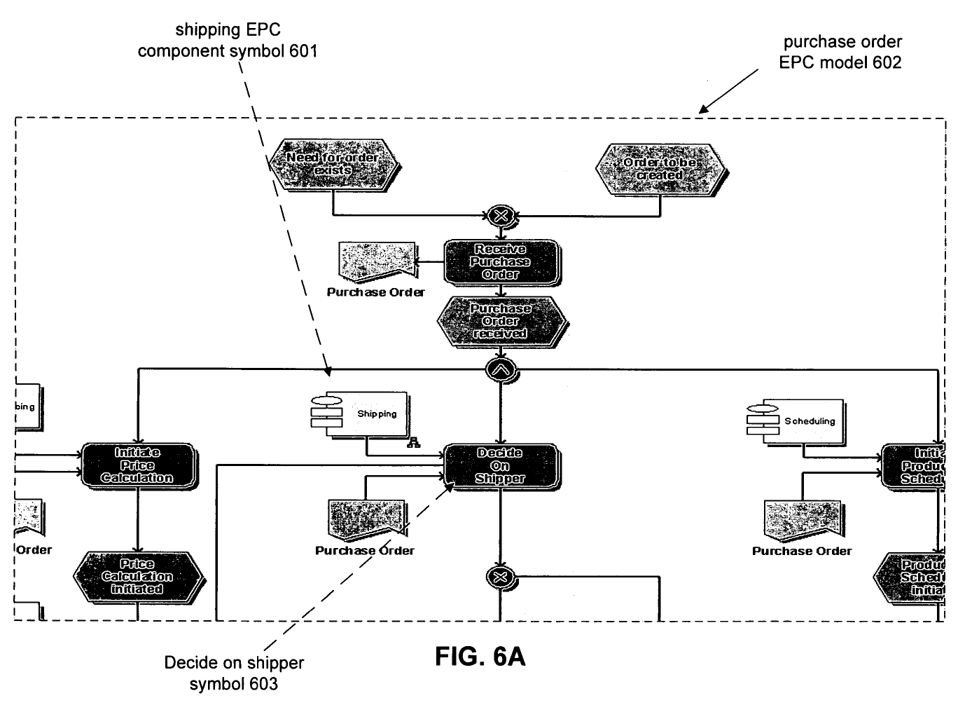

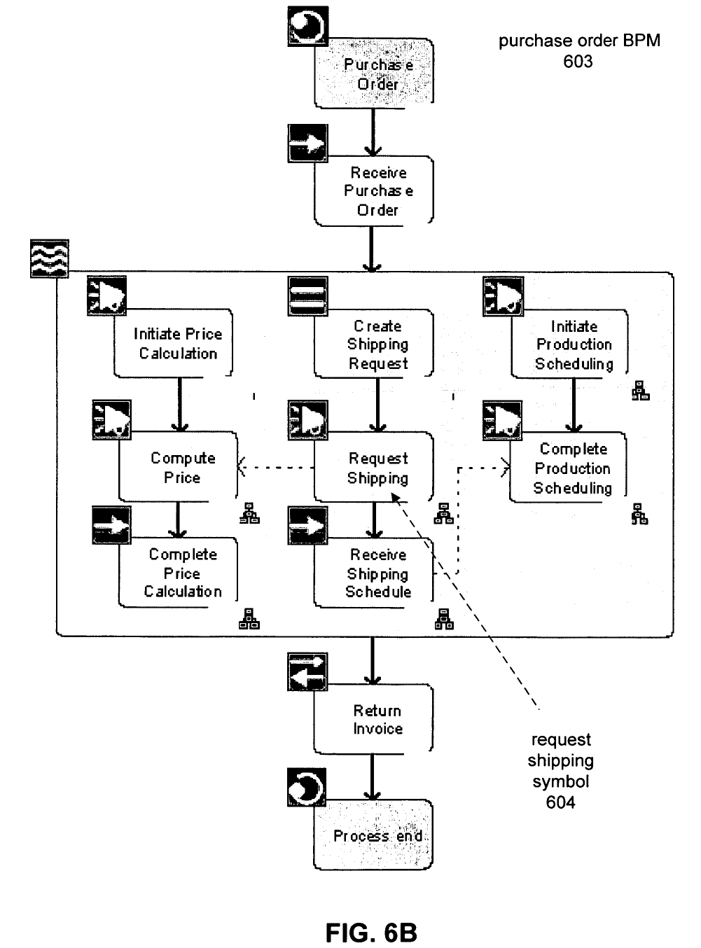

A “symbol” is a graphical way of representing an object in a model. Symbols within a model are consistent with the description notation used for creating the model, and can be associated with different object types. Symbols can have a narrower meaning than that of the object they represent, depending on how the description notation is defined. Symbols can also be used in a model to represent relationships between objects, such as a line between the objects. An example of a symbol is function symbol 203, shown in FIG. 2C. Function symbol 203 appears, for instance, in FIG. 6A as decide on shipper symbol 603. This is a shorthand convention used throughout the document to describe the idea that function symbol 203 is being used to represent an object named “decide on shipper.” Thus, “shipper symbol 603” means “decide on shipper object represented by a function symbol.”

“Representing” is a way of describing an object and a symbol. A symbol represents an object if the object appears (has an occurrence) as the symbol in some model. Multiple symbols can be used to represent different occurrences of an object.

“Occurrence information” is information indicating an object is represented by a symbol in a model. An object can appear multiple times in one or more models as different symbols, if so we say the object has multiple occurrences. For example, occurrence information can be used to show that customer order processing object, generally shown in FIG. 5B as 511, has an occurrence, i.e. appears as a symbol, in VAC 500.

“Assigning” can occur from a model to an object, or from an object to a model. An object being assigned to a model can be used to mean the object has an occurrence in the model; this type of assignment can be an example of occurrence information discussed above. A model being assigned to an object can mean that the model provides either further refinement of the object at a different layer of a view hierarchy, that the model provides more detail about the object at the same layer of a view hierarchy, or that the object appears in the model as a symbol. An example of this type of assignment can be BPM 603 being assigned to customer order processing object 511, or UML component diagram 700 being used to give a detailed description shipping EPC object generally shown as 511.

“XML” (extensible markup language) is a computer language, and “XML Schema Definition” (XSD), and “Document Type Definition” (DTD) are ways of describing the structure of an XML document.

“BPEL” is a notation for specifying business process behavior, described in “Business Process Execution Languages for Web Services, Version 1.1,” May 5, 2003. The BPEL specification is available at: http://dev2dev.bea.com/technologies/webservices/BPEL4WS.jsp.

BPEL symbols are graphical illustrations of constructs defined by the BPEL specification. They can be used as a description notation for modeling, and also for the generation of BPEL-compliant XML code.

“Value-added chains” specify the functions in a company which directly influence the real added value of the company. These functions can be linked to one another in the form of a sequence of functions and thus form a value-added chain.

“BPMN” is business process modeling notation, “ERM” is the Information Architecture entity relationship model, “UML” is unified modeling language, and “IDEFX” is Integrated DEfinition Methods (the “x” corresponding to different versions of IDEF). “UML component diagrams” are a way of modeling business software architecture or technical software architecture.

“SAP-SERM” (SAP structured entity relationship model) is an extension of SERM (structured entity relationship model). “OMT” (object modeling technique) is a software engineering methodology that can utilize a graphical description notation. A “program flow chart” allows all relationships with application system types, module types and IT function types available in the other model types of ARIS to be modeled regardless of the ARIS division into views.

“BSC” (Balanced score card) is a management system that can be described in a description notation. “PROMET” (PROcess METhod) is a systematised procedural methodology available from www.img.com. “Process support maps” show a matrix of process steps and systems mapped on organizational units, and are also known as business support maps. “SeDaM” is a data modeling from BASF AG.

Generally speaking, different description notations and different versions of description notations can be used with or adapted to an embodiment of the invention.

An “execution language description notation” is a description notation for execution languages, such as XML, BPEL, or WSDL (Web Services Description Language).

“Executable code” means code that is either in a format suitable for use by a computer, or suitable for use by a compiler, linker, interpreter, or other means for automatic translation into machine language. An example of executable code is BPEL-compliant XML.

“Navigation” means changing displays of different graphical elements on a screen, to show, for example, related models, objects, or symbols. An interface is a part of a system used to exchange information between systems.

A “graphical representation” is a visual way of illustrating a concept. A graphical representation may be, for example, a symbol, a number of symbols, a model, an icon, or any other displayable element.

A “business process model” is a model of a sequence of steps, executed to achieve a business result. According to the meta-model, each step can result in the change of state of a business object. Business processes can be part of, triggered by, and superior to other business processes. Business processes can be modeled in a hierarchy. As described herein, the business process hierarchy consists of a requirements definition, design specification, and implementation description level, but other ways of defining a business process or other view hierarchy are possible, and supported by the ARIS platform. The methods described herein are described with respect to an embodiment illustrating a process view of information. Thus, the models described herein are written in description notations appropriate for process modeling. However, the methods are equally applicable to business information other than processes, such as data, organization, functions, and products and services. An example of a business process model is BPM 603.

For purposes of illustration, embodiments of the invention are described herein with reference to implementations using an ARIS environment. As will be appreciated by one skilled in the art, however, embodiments of the invention are not limited to ARIS, and may be applied in other environments, including computerized or software-based environments with modeling and/or graphical tools. As used herein, the term “software” encompasses any and all types of software, including computer software, computer program products, and program modules and components, including business and financial software applications and components.

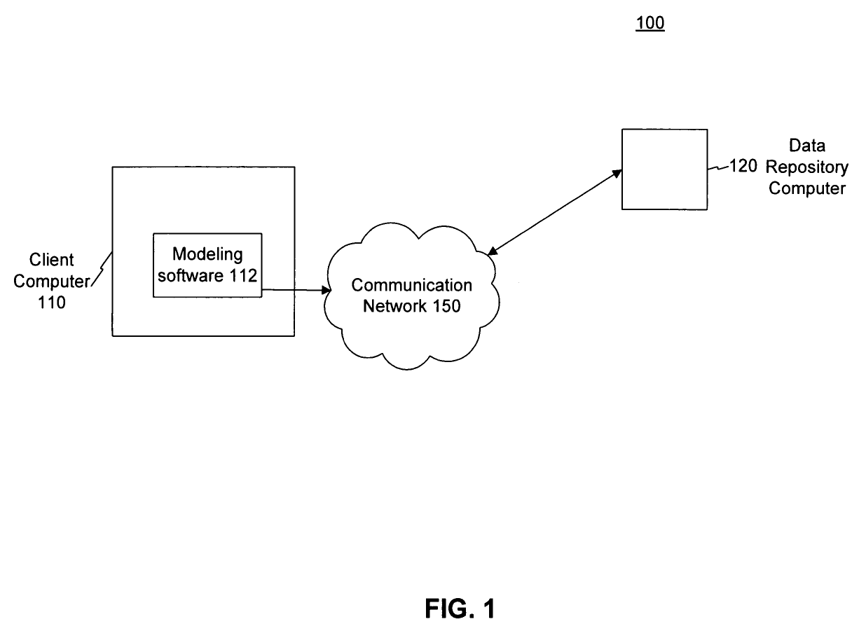

FIG. 1 illustrates a block diagram of an exemplary modeling system 100, consistent with an embodiment of the invention. Modeling system 100 may include one or more client computers 110 with modeling software 112, and one or more data repository computers 120. Modeling software 112 may generate one or more graphical user interfaces (GUIs) to assist a user in defining and creating VACs, objects, EPCs and BPEL process models. The GUIs may include a work space and a repository from which symbol representations and other graphical elements may be selected and arranged in the work space and subsequently stored. Each of the computers 110 and 120 can include one or more processors, storage devices, applications, and other hardware or software. Communication network 150, which can be implemented by any combination of wired or wireless technologies, allows computers 110 and 120 to communicate. Communication network 150 can be virtually any type of network, including a WAN such as the Internet, or a home or office-based LAN.

For the purposes of this description, the major conceptual functions of the invention are described as wholly resident on separate computers. Alternative embodiments wherein the processing described on any one of the computers 110 and 120 is distributed across multiple computers are also possible. In addition, it is possible to combine the functionality of one or more of the computers 110 and 120 into one machine. For example, modeling software 112 can exist entirely on server distinct from computers 110 and 120, or modeling software 112 can be split between computer 110 such a server. Such a server can be on a LAN or WAN with computers 110 and 120. A preferred embodiment is to have modeling software 112 on a server, the server connected by a LAN to data repository computer 120, and computer 110 connected by a WAN to both the server and data repository computer 120.

The exemplary methods and features disclosed herein for storing, displaying, and navigating through models are described with reference to a “meta-model” underlying the models and objects that appear within them. Regardless of the view of business information or layer of a view hierarchy that a given model may correspond to, the model and symbols within the meta-model have certain conventions they adhere to. The meta-model will be described with respect to the process view, and thus to the process hierarchy, but the method is consistent with other views and view hierarchies. Data consistent with the meta-model can generally be referred to as “integrated model data.”

Models are stored on data repository computer 120 (generally shown as 512 in FIG. 5B), and each symbol in a model can represent an object, also stored on data repository computer 120 (generally shown as 511 in FIG. 5B). An object can be, for example, a data structure, such as a class, structure, or array. Objects can have types, each type can be used to delineate different general concepts within the meta-model, such as a function or event object type. A symbol thus reflects the meaning of the object type for the object the symbol represents, within the context of the model where the symbol appears. As discussed above, models are written in “description notations,” and the description notation for a given model is generally chosen because it is appropriate to the view and view hierarchy level which the model corresponds to.

The ARIS framework allows various graphical description notations, and can be extended to textual description languages as well. Models can be implemented in a graphical description notation using symbols that are defined by the notation. For example, ARIS EPC symbols are depicted in FIGS. 2A-E. Event symbol 201 in FIG. 2A illustrates an event, which indicates that an object has taken a business-relevant status which is controlling or influencing the further procedure of the business process. Function symbol 203 in FIG. 2C illustrates a function. Events trigger functions, and are the results of functions. Unlike a function, which is a time-consuming occurrence, an event is related to one point in time. A function is a technical task or activity performed on an object in support of one or more company objectives. Rule symbol 205 in FIG. 2E illustrates a rule. Rules define the logical links between the objects they connect. Information carrier symbol 202 in FIG. 2B illustrates an information carrier, which describes input/output data for functions. Component symbol 204 in FIG. 2D illustrates a component, which describes services supporting the execution of a function.

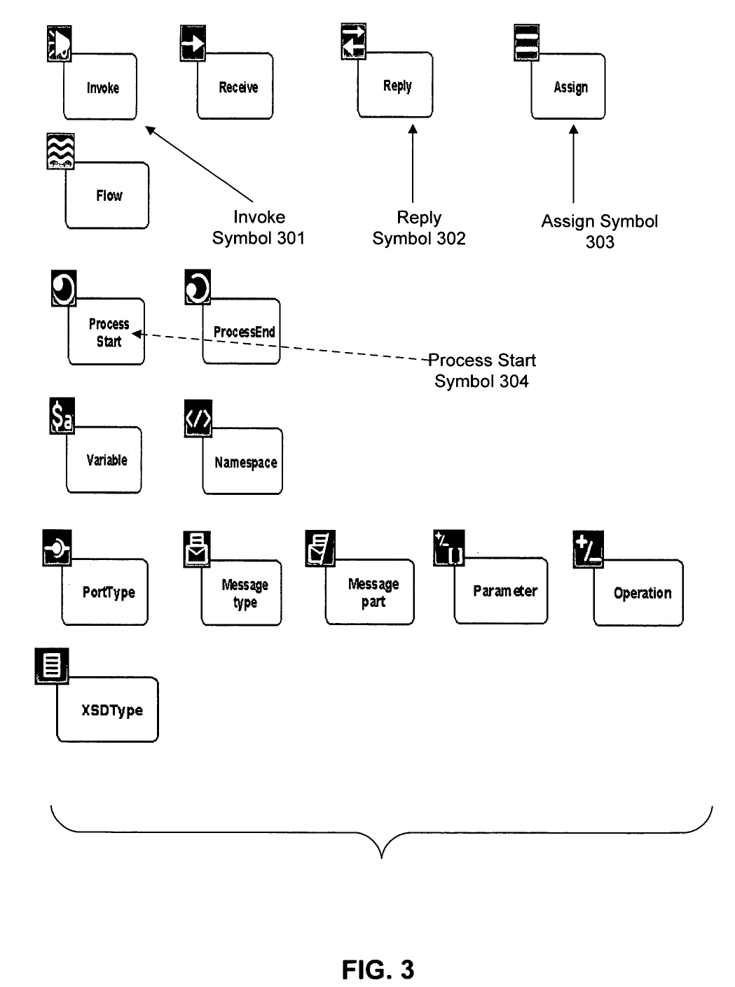

Another example of a graphical description notation provided by ARIS is illustrated in FIG. 3. FIG. 3 depicts a number of ARIS BPEL symbols. Each BPEL symbol represents a BPEL concept defined by the BPEL standard. For example, invoke symbol 301 illustrates invoking an operation, and is described at Chapter 11.3 of the BPEL standard. Assign symbol 303 is an abstract depiction of an assignment and is described in Chapter 11.5 of the BPEL standard (note this symbol illustrates the BPEL concept of “assign,” not assignment as discussed with respect to the meta-model). Reply symbol 302 illustrates an action in reply to an incoming action, and is described in Chapter 11.4 of the BPEL standard Each of the BPEL symbols depicted in FIG. 3 corresponds to a BPEL concept described in the standard. Other BPEL symbols are defined in ARIS, but are not shown.

The methods described for storing, displaying, and navigating through models are facilitated by the use of a single “meta-model” underlying the models and objects that appear within them. The meta-model is a set of rules that defines conventions for models and objects within data repository computer 120. Regardless of the layer of the view hierarchy or view that a given model may correspond to, the model adheres to the conventions defined by the meta-model. Likewise, when an object appears as a symbol in a model, it follows the conventions defined by the meta-model, regardless of what description language the symbol corresponds to. This is true even if the object appears in several models, and in several different description notations.

By defining a set of underlying rules for objects and models stored on data repository computer 120, the meta-model provides a framework for a modeling tool. This framework enables the modeling tool to be used for developing, maintaining, displaying, and navigating through different models, in different description languages, and at different layers of the view hierarchy. The meta-model has three basic facets for using symbols, models, and objects that allow it to be used to integrate the various models, description notations, and layers of the process hierarchy.

In one exemplary embodiment, the “objects” and “models” are both stored in the form of a programming construct known as a “structure,” each structure having one or more “fields” which can be set to particular values. The structures for the models and objects within the data repository computer 120 are defined in a way consistent with the meta-model. Alternative embodiments include using virtually any other sort of data structure, including the use of arrays, dynamic memory, classes, tables, etc., in place of the structures discussed herein. It is also possible to use a variety of different data structures to implement the meta-model, for example using storing objects as structures and models as classes.

The first facet of the meta-model is that objects can have “occurrences” within several models. Symbols within a model can represent objects. Each appearance of an object within a model is called an “occurrence” of the object; multiple occurrences amount to reuse of an object. Objects can have occurrences in more than one model, and in models in different description notations and at different layers of the process hierarchy. An occurrence of an object within a model can give a narrower meaning for the object, consistent with the meaning of the symbol representing the object in the model's description notation.

If an object is stored as a structure, the object can have an “occurrence” field, which can be a linked list, for example. When an object is represented in a model by a symbol, the “occurrence” list for the object can get a new entry equal to the new model. Similarly, models defined as structures can have an “objects” linked list, and when a new symbol is added to the model, an object represented by the symbol can be added to the linked list. If occurrences are deleted from models, the corresponding list entries can be deleted from the object and model structures. Other implementations using both static and dynamic memory will readily occur to those skilled in the art.

A second facet of the meta-model is that models can be “assigned” to objects, and objects to models. This allows for easy two-way retrieval of objects which have occurrences in models (the model's assigned objects) and models which have information relevant to a particular object (the object's assigned models). The assignment mechanism allows for two complementary goals to be achieved.

First, by assigning a model at the same level of process hierarchy to a given object, the object can appear as a “black box” within one model, i.e. without all of the details for the object. A second model can be assigned for the object for the purpose of showing the details of the object, at the same level of process hierarchy. This allows for creation of less cluttered models without forcing a user to give up information content.

Second, a model from a different level of the process hierarchy can be assigned to a particular object. Thus, an object could have, for example, a design specification model assigned to it, so that implementation details are not described in the model. The object could also have an implementation description model assigned to it, describing the object's implementation.

This aspect of the invention can be implemented by using a linked list “assigned models” field in each object defined as a structure, and creating a new entry in the list for each model assigned to an object. If models are to be de-assigned from an object, the corresponding entry can be deleted. Note that the term “assign” as used herein generally refers to storing data indicating a first data structure is assigned to a second data structure, generally a model to an object or an object to a model. The assigned model can provide details or refinement about the object. While one embodiment consistent with the invention is disclosed where structure fields are used to store assignments, other embodiments are contemplated, such as storing a table, database, or other data representation. Similarly, a linked list can be used to store objects assigned to a model.

The third facet of the meta-model is that it allows for “relationships” to be defined between objects. The relationships can be, for example, relationships that are relevant within UML, such as one object is a member of another object, or has another object as a parameter. Another example of a relationship between objects can be described using an organization and an activity. Assuming organization Y performs activity A, and organization Z needs to be informed whenever activity A is performed, object relationships can be used to delineate this structure. For example, an object that implements activity A can have a “performed by” relationship with organization Y, and an “inform when performed” relationship with organization Z. In one embodiment of the invention, an object keeps a list of its relationships, and any relationship can have a “source” object and a “target” object. A “source” object could be, for example, an object that causes a function to occur, and a “target” object could be the function.

An object defined as a structure can have a “related objects” linked list, which is a list of substructures having fields “object” and “relationship.” If a new relationship is defined for a first object with a second object, an entry can be added to the list for the first object, and the “object” field of the entry set equal to the second object, or a reference to it. Similarly, the “relationship” field of the new entry would be set to a value for the relationship between the objects, for example an enumerated type. In the example discussed above, the relationship type could take on values including “PerformedBy and InformWhenPerformed.” Thus, the object for activity A would have a list entry in it's “related objects” list with “Y” as the object field and “PerformedBy” as the relationship field. Similarly, the object for activity A would have a list entry with “Z” as the object field and “InformWhenPerformed” as the relationship field. A relationship between two objects can also be represented graphically in a model, by a symbol.

The meta-model, by allowing flexible occurrences of objects, assignments of models to objects, and relationships between objects, enables users to develop multiple models using the same toolset. The meta-model also promotes data consistency by allowing for reuse of objects within different models. The meta-model also allows for easy navigation between different models.

The meta-model also includes different types of objects, and rules for which symbols can represent a given object type in a model. As an example, a BPEL “Invoke” symbol 301, as shown in FIG. 3, could be an occurrence of an object of type “function.” The function object type is defined by the meta-model to include certain information, for example structure fields indicating parameters for the function. The BPEL “Process Start” symbol 304 as shown in FIG. 3 could be an occurrence of an object of type “event,” which can include, for example, structure fields indicating what kind of event it is.

The meta-model also defines relationships that can exist between object types. For example, a function object could have a related objects linked list with as discussed above. A substructure entry for an event object could have the event object as the object field of the entry, and “TriggeredBy” as the relationship field of the entry. However, an event object could not have a “TriggeredBy” relationship with another event object, as the meta-model prohibits this relationship.

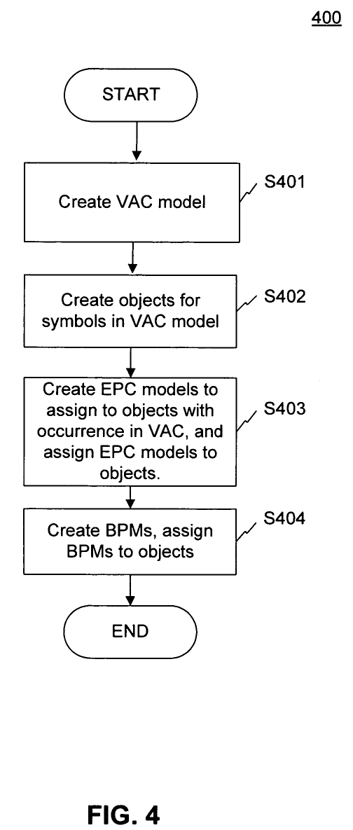

FIG. 4 is an exemplary flowchart 400 of an exemplary method, consistent with an embodiment of the invention. The exemplary method of FIG. 4 may be implemented for integrating data for modeling a business process, by assigning models to a object.

At step S401, a value-added chain model (VAC) is created, and stored on data repository computer 120 (generally shown as 512 in FIG. 5B). As part of this step, a user at client computer 110 may define and create a VAC for one or more business processes, for example. For purposes of illustration, assume that the VAC 500 shown in FIG. 5A is created at client computer 110 using one or more graphical user interfaces provided by modeling software 112. As shown in FIG. 5A, VAC 500 includes symbols representing several high-level steps performed by the business, including “customer order processing” represented by symbol 501. As discussed above, VAC diagrams are generally used at the requirements definition level to model at a high level and with relatively little detail.

At step S402, modeling software 112 may be further used to create objects represented by each symbol in the VAC. In an alternative embodiment consistent with the invention, objects are automatically created each time a symbol is used in a model. Objects can also be created and displayed on a GUI using a default symbol, which is normally a symbol not defined by a description notation. For instance, for the exemplary VAC 500, a customer order processing object 511 along with other objects 511 (see FIG. 5B) may be created and stored in data repository computer 120. The symbols in VAC 500 can represent an “occurrence” of an object represented by the symbol, for example customer order processing symbol 501 is an occurrence of customer order processing object 511. The objects may be stored with information indicating that they have an occurrence in VAC 500, along with information indicating how the objects are to be displayed as symbols in VAC 500.

At step S403, client computer 110 may be used to create an EPC model for each object represented by a symbol in the VAC. Returning again to the example of VAC 500, a purchase order EPC model 602 may be created (see FIG. 6A, showing a partial view of the full model) using, for instance, graphical user interfaces provided by modeling software 112. Purchase order EPC model 602 may be created as a model intended to be assigned to customer order processing object 511, which is represented by customer order processing symbol 501 in VAC 500. The assignment allows the meaning of customer order processing object 511 to be refined. Purchase order EPC model 602 is stored on data repository computer 120, in a manner similar to other models 512.

Objects may be created for each symbol in purchase order EPC model 602 or, as explained later, preexisting objects can be brought into purchase order EPC model 602. In one embodiment, client computer 110 may have a GUI for indicating to modeling software 112 that purchase order EPC model 602 should be assigned to customer order processing object 511. Modeling software 112 then stores information that assigns purchase order EPC model 602 to customer order processing object 511. Modeling software 112 then sends information to data repository computer 120 to update customer order processing object 511 to reflect the assignment of purchase order EPC model 602. As discussed above, this can be done by storing a value in a structure or other data structure type.

At step S404, client computer 110 may be further used to create one or more BPEL process models (BPMs), which are stored on data repository computer 120 and generally illustrated as 512 in FIG. 5b. For instance, a purchase order, BPEL process model (BPM) 603, as shown in FIG. 6B, may be created by a user using one or more graphical user interfaces provided by the modeling software 112. Purchase order BPM 603 can be created as a design specification model for customer order processing object 511, and stored in the same manner as other models 512. Objects can be created and stored in data repository computer 120 for each symbol in purchase order BPM 603, preexisting objects can be reused in purchase order BPM 603, or symbols can be used as placeholders in BPM 603 without creating objects. Client computer 110 may also be used to provide modeling software 112 information indicating that purchase order BPM 603 is to be assigned to customer order processing object 511. Modeling software 112 then assigns purchase order BPM 603 to customer order processing object 511 and sends information to data repository computer 120 to update customer order processing object 511 to reflect the assignment of purchase order BPM 603. As discussed above, this can be accomplished by storing customer order processing object 511 as a structure, and updating it's fields to indicate the assignment of purchase order BPM 603.

According the example described above, two models, purchase order EPC model 602 and purchase order BPM 603 have been assigned to customer order processing object 511. Customer order processing object 511 has an occurrence in VAC 500. As will be seen later, because these models have been assigned to customer order processing object 511, whenever an occurrence of VAC 500 is displayed, it will be possible to navigate to either purchase order EPC model 602 or purchase order BPM 603, to obtain more refined representations of customer order processing object 511.

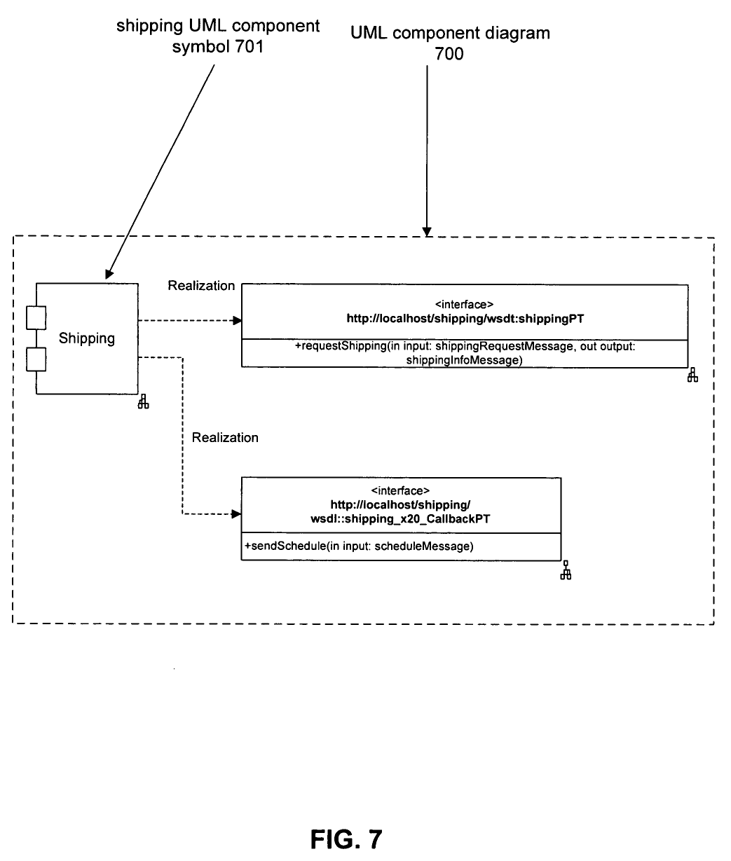

In a similar manner as described above with respect to FIG. 4, other objects can have models assigned to them. For example, a shipping EPC component symbol 601 is shown in FIG. 6A. When shipping EPC component symbol 601 was inserted into the model, an object represented by the symbol may have been created. Now, if a detailed description of the object represented by shipping EPC component symbol 601 is desired, a new model can be created and assigned to the object as discussed above. For example, FIG. 7 illustrates a UML component diagram 700. UML component diagram 700 can be created as a model, in order to give a detailed description of shipping EPC object generally shown as 511 represented by shipping EPC component symbol 601.

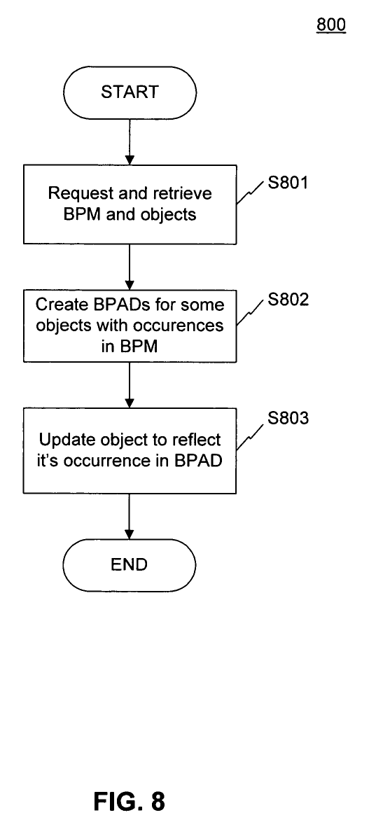

FIG. 8 is a flowchart 800 of another exemplary method, consistent with an embodiment of the invention. The exemplary method of FIG. 8 may be implemented for the purposes of reusing an object represented by a symbol in a BPM (such as purchase order BPM 603) within a model that explains the conceptual details of the object it represents.

At step S801, a user may instruct client computer 110 to request a BPM (e.g., purchase order BPM 603) from modeling software 112. Modeling software 112 then requests information about purchase order BPM 603 from data repository computer 120, along with objects having occurrences within purchase order BPM 603. In this example, request shipping symbol 604 in purchase order BPM 603 is the only occurrence of a request shipping object (generally shown as one of the objects 511 in data repository computer 120 in FIG. 5B). Modeling software 112 may retrieve purchase order BPM 603 from the information stored in data repository computer 120, and display purchase order BPM 603 on client computer 110.

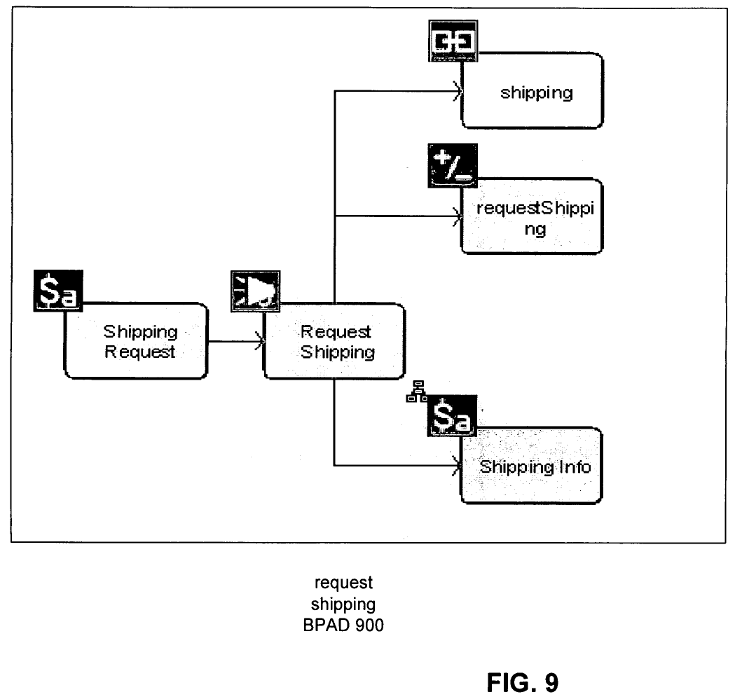

At step S802, the user at client computer 110, using interfaces provided from software 112, creates a request shipping BPEL allocation diagram (BPAD) 900, as shown for example in FIG. 9. Request shipping BPAD 900 provides details about request shipping object, generally shown as 511. Thus, while BPEL process models such as purchase order BPM 603 illustrate the business process, allocation diagrams such as request shipping BPAD 900 illustrate the implementation details of elements within the business process. This allows details of a model to be hidden within another model at the same level of the process hierarchy. Further, note that the recently created request shipping BPAD 900 includes a symbol called “request shipping” as well, which is an occurrence of an object represented by the symbol.

If the user starts to create request shipping BPAD 900 and tries to include a symbol called “Request Shipping,” modeling software 112 will prompt the user that there is already a “Request Shipping” object in the repository, and ask if the user would like to reuse the object in request shipping BPAD 900. Also, a user can be provided with an interface displaying object names in the data repository computer 120, so they can drag and drop objects from the repository into a model. Similarly, an existing symbol can be dragged from a first model into a second, to create an occurrence of the object in the second model. Multiple objects that have similar meanings can be consolidated into one object.

At step S803, the user may instruct client computer 110 to send information about request shipping BPAD 900 to modeling software 112. In another embodiment consistent with certain aspects of the invention, this can happen automatically. Included is information indicating that request shipping object 511 occurs in request shipping BPAD 900. Request shipping object 511 is thus updated to have a new occurrence, in request shipping BPAD 900.

In a similar manner as described above with respect to FIG. 8, BPEL allocation diagrams can be created and assigned to objects that have occurrences within other BPEL allocation diagrams. Thus, BPADs can be used to provide details about objects having occurrences in either BPMs or other BPADs.

In the above-described embodiments, several models are have been described, including VAC 500, purchase order EPC model 602, purchase order BPM 603, UML component diagram 700, and request shipping BPAD 900. Both purchase order BPM 603 and request shipping BPAD 900 have an occurrence of request shipping object 511. In purchase order BPM 603, request shipping object 511 is represented atomically, as an element within a business process description. However, request shipping BPAD 900 contains more detailed information about request shipping object 511.

Request shipping BPAD 900 and purchase order BPM 603 are symbolic illustrations of BPEL code, and each symbol in these models maps to one or more BPEL programming constructs. As explained below, because request shipping object 511 has it's detailed description stored as request shipping BPAD 900, when request shipping object 511 is displayed as a symbol in a higher-level model it will be possible to navigate to it and obtain a detailed representation of request shipping object 511.

The above-described embodiments have been presented with reference to a “top down” example of modeling. The description started with a very high-level VAC diagram (see, e.g., FIG. 5A), and progressively models were created that either gave more detail to existing objects or illustrated related concepts at different layers of the process hierarchy. However, as will be appreciated by one skilled in the art, embodiments of the invention need not occur in a top-down fashion.

For example, when shipping EPC component symbol 601 is placed into purchase order EPC model 602, a shipping object (generally shown as one of the other objects 511 in FIG. 5B) can be created. UML component diagram 700 need not be created to describe shipping object 511 at this time. At some point, if it becomes desirable to more fully describe shipping object 511, UML component diagram 700 may be created and both an occurrence of shipping object 511 placed into UML component diagram 700, and an assignment of UML component diagram 700 to shipping object 511 at this time.

In one embodiment consistent with the invention, UML component diagram 700 can be a preexisting model. In this case, shipping object 511 could have been created when UML component diagram 700 was created, represented by shipping UML component symbol 701. When purchase order EPC model 602 is created, the user can simply drag and drop either shipping object 511 illustrated in a GUI, or the object's representation by shipping UML component symbol 701, into EPC 602. This will create a new occurrence for shipping object 511 in EPC model 602. Both models can also be assigned to shipping object 511.

Shipping object 511 may appear as an appropriate symbol for the description notation in which a particular model is written. In purchase order EPC model 602, the object is represented symbolically in EPC notation as shipping EPC component symbol 601 (an example of EPC component symbol 204), whereas in UML component diagram 700 the object is represented as a shipping UML component symbol 701. Thus, the symbol used to represent the object changes with the description notation in which the object is represented, but the object's underlying meaning stays the same. Likewise, because request shipping object 511 appears both in purchase order BPM 603 and request shipping BPAD 900, it may appear as a symbol appropriate to the description notation used in those models. Because ARIS BPEL symbols are the description notation used in both of these models, request shipping object appeared represented by an example of invoke symbol 301 in each case.

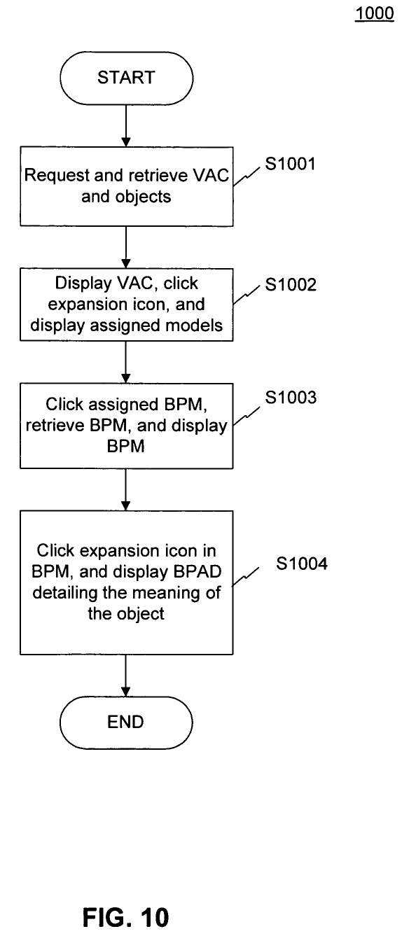

FIG. 10 is a flowchart 1000 of an exemplary method, consistent with an embodiment of the invention. The exemplary method of FIG. 10 may be implemented to enable a user to navigate from abstract, high-level models describing business processes to detailed descriptions of how those processes are implemented, to models written in different description languages, and to models at different layers of the process hierarchy.

At step S1001, a user at client computer 110 requests a VAC (such as VAC 500) from modeling software 112. Modeling software 112 then requests information about VAC 500 from data repository computer 120, along with information about objects having occurrences in VAC 500.

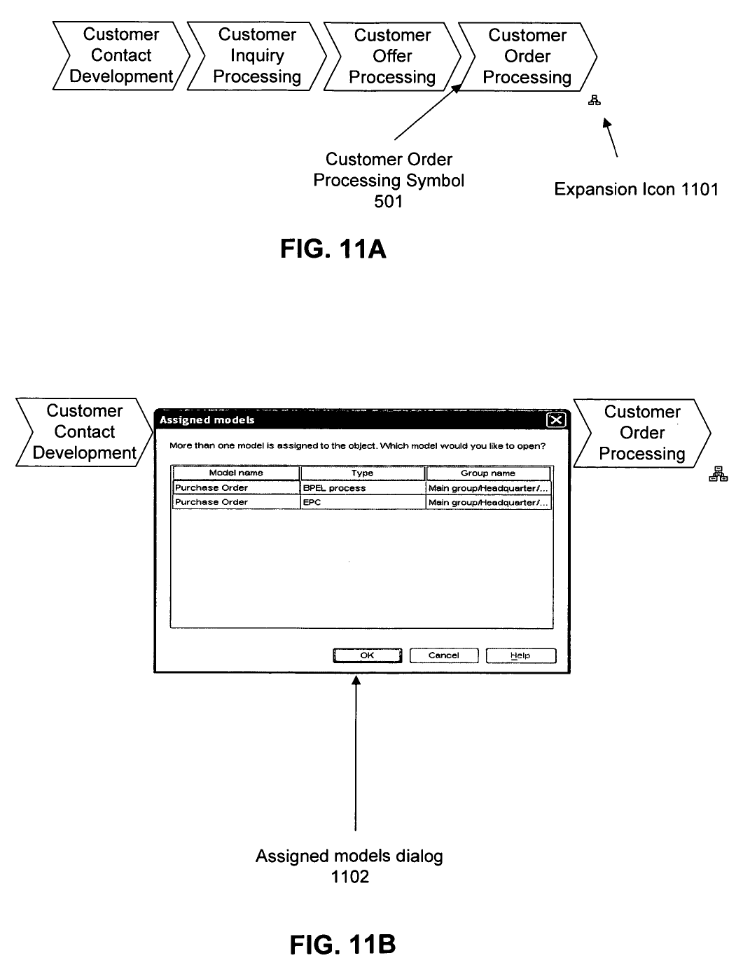

At step S1002, modeling software 112 displays a graphical representation of VAC 500 on client computer 110. As part of this step, VAC 500 may appear as shown in FIG. 11A. In accordance with an aspect of the invention, customer order processing symbol 501 is now displayed with an expansion icon 1101 displayed nearby. Expansion icon 1101 indicates to the user that there are one or more models assigned to customer order processing object 511, which is represented by customer order processing symbol 501. Expansion icon 1101 can be displayed based on the data stored in repository computer 120. Other methods of indicating assignments or include altering the appearance of the cursor or symbol, such as size, shading, color. As will be shown later, expansion icon 120 can be used to indicate that it is possible to navigate to a model assigned to an object represented by symbol by clicking the expansion icon. Expansion icon 1101 can also be used to navigate to an assigned model. Alternative methods of navigating include, for example, double-clicking on the symbol and/or indicating an interface for navigating by providing an active cursor that changes its style when passed over the symbol.

At step S1002, the user may select expansion icon 1101 by moving a cursor and clicking on the icon with a mouse device, for instance. Client computer 110 then responds to a click event on expansion icon 1101 by retrieving the models and assigned to the object represented by the symbol, and displaying them to the user, as shown in FIG. 11B. In particular, FIG. 11B illustrates VAC 500, along with an expanded view of assigned models dialog 1102. Assigned models dialog 1102 displays information (model names, type, group, etc) indicating what models are assigned to customer order processing object 511. If the user causes client computer 110 to further receive a click event on assigned model dialog 1102, client computer 110 will retrieve and display the specific model listed at the place on assigned model dialog 1102 that was clicked.

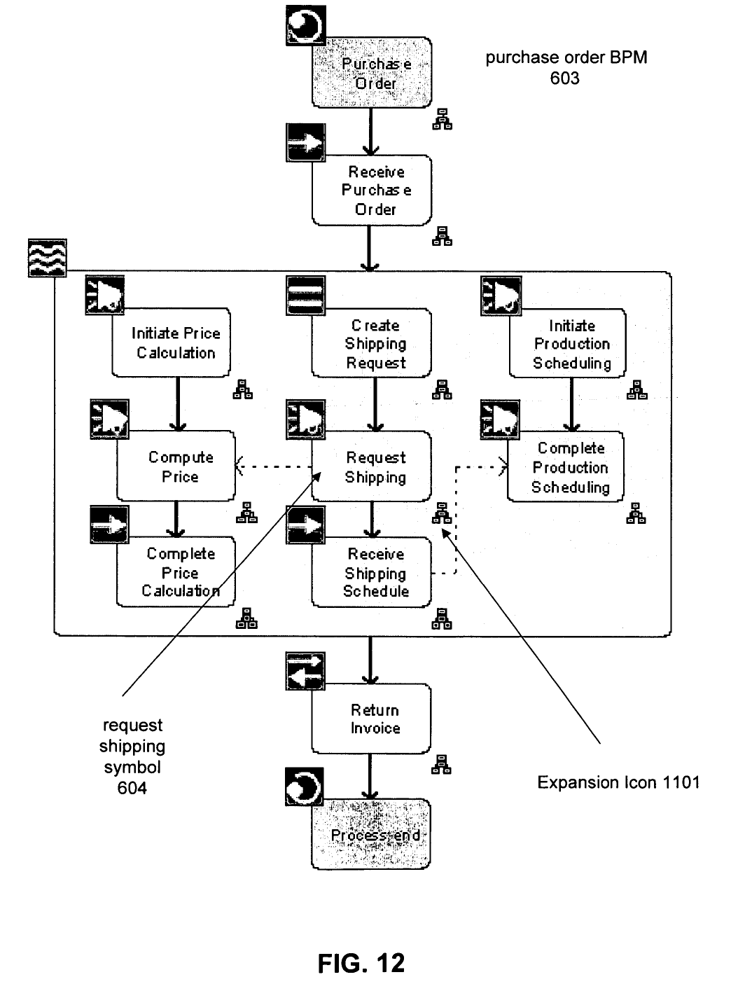

For instance, if the click occurs at model name=“Purchase Order” and type=“BPEL Process,” client computer 110 will respond by requesting purchase order BPM 603 from modeling software 112. Modeling software 112 will then retrieve the necessary information from data repository computer 120, and send purchase order BPM 603 to client computer 110 for display. Purchase order BPM 603 is then displayed to the user, such as that shown in FIG. 12. In particular, request shipping symbol 604 now has expansion icon 1101 displayed nearby. As described earlier, expansion icon 1101 can be used to indicate an object represented by a symbol has a model assigned to it, thus request shipping object 511 has the model assigned to it. The expansion icon can be used to provide an interface for navigating between models of more or less refinement than a currently displayed model, and to models which provide more or less detail than a currently displayed model. The appearance of the expansion icon can be varied, for example size, shape, or color, to indicate if more detailed, more abstract, or different process hierarchy layer models are available for an object. Further, the location of an expansion icon relative to a symbol may indicate a direction of navigation. For instance, when placed in a lower corner of the symbol, a user may navigate down to more detail by selecting the expansion icon. If, however, the icon is provided on an upper corner of the symbol, then the icon can be used as an interface to navigate up and to more general views or levels.

At step S1004, a click event occurs on expansion icon 1101 next to request shipping symbol 604. In this case, since there is only one model assigned to request shipping object 511, the model is requested immediately, instead of displaying a choice of models to request. As a result, client computer 110 requests request shipping BPAD 900 from modeling software 112, modeling software 112 retrieves the necessary information from data repository computer 120, and modeling software 112 displays request shipping BPAD 900 on client computer 110.

Consistent with embodiments of the invention, a user can navigate between models for several purposes. A user can navigate between models in different description notations. This facility also enables navigating between different layers of the process hierarchy. As discussed above, certain description notations can be preferred for modeling or describing particular layers of the process hierarchy. The navigational aspects of the invention may also allow users to readily model at a given layer of the process hierarchy using a description notation of their choice, while maintaining the freedom to navigate between the models.

A user can also create models that allow the user to have symbols encapsulate the concept of a represented object in a general manner in one model, and assign another model to the object that provides more detail about the meaning of the object. This in turn allows users to see the “big picture” by viewing a model with less detail, and navigating only to the detailed models that they wish to view.

Other embodiments and arrangements will be apparent to those skilled in the art in view of this disclosure. For instance, while certain embodiments of the invention have been described with reference to computerized systems or components, computer-readable media can be used to provide computer-readable instructions for performing a methods and features consistent with the invention.

Embodiments of the invention has been described with respect to a process or control view of the process hierarchy, however, the invention is equally applicable to other views that can be used to describe a business process or other activity, including for example an organization, data, function, or products/services view. Different description notations as desired may be used to describe the different views, and these description notations and levels of the process hierarchy can be integrated and navigated consistent with the principles of the invention.

Embodiments of the invention have been described with respect to a limited set of description notations. However, any description notation appropriate for modeling can be used in an embodiment consistent with the invention. Non-limiting examples include BPMN (business process modeling notation), the Information Architecture entity relationship model (ERM), unified modeling language (UML), and Integrated Definition Methods (IDEF).

Similarly, the process hierarchy described is not a limiting example. While the description of the invention has been constrained to the three level process hierarchy as described, additional levels of process hierarchy can be defined and used in a manner consistent with the invention.

The systems and methods disclosed herein may be embodied in various forms of apparatus including, for example, a data processor, such as a computer that also includes a database, digital electronic circuitry, memory, firmware, software, or in combinations of them. Moreover, the above-noted features, and other aspects and principles of the disclosed system and methods may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

The systems and methods disclosed herein may be implemented as a computer program product, that is, a computer program tangibly embodied in an information carrier. Such an information carrier may be embodied in a machine readable storage device or in a propagated signal, for execution by, or to control the operation of, data processing apparatus, e.g., a programmable processor, a computer, or multiple computers. A computer program can be written in any appropriate form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Accordingly, it is to be understood that the foregoing description is intended to illustrate and not to limit the scope of the invention, which is defined by the scope of the appended claims.

What is claimed is:

1. A method for modeling business information with integrated model data, the method comprising the steps of:
storing a first business information model, the first business information model comprising a first description notation;
storing a second business information model, the second business information comprising a second description notation, the second description notation not necessarily being different from the first description notation; and
assigning the second business information model to an object, the object being represented by a symbol in the first business information model;
wherein at least one of the first description notation and the second description notation is an execution language description notation.

2. The method according to claim 1, wherein a description notation of the first description notation and the second description notation is one from the group comprising: an event-driven process chain notation, XML, BPEL-compliant XML, BPEL represented as graphical symbols, UML component diagram notation, value-added chain notation, BPMN, ERM, UML, IDEFX, BSC, XSD, DTD, SAP-SERM, OMT, SeDaM, PROMET, a program flow chart, and a process support map.

3. The method according to claim 1, wherein at least one of the first description notation and the second description notation includes one or more symbols that can be used to generate executable code.

4. The method according to claim 3, wherein the executable code is a BPEL-compliant XML code.

5. The method according to claim 1, wherein at least one of the first business information model and the second business information model is a business process model.

6. A method for modeling business information with integrated model data, the method comprising the steps of:
storing a first business information model, the first business information model being written in a first description notation;
storing a second business information model, the second business information model being written in a second description notation, the second description notation not necessarily being different from the first description notation; and
storing occurrence information for an object indicating that the object is represented by both a symbol in the first business information model and a symbol in the second business information model,
wherein at least one of the first description notation and the second description notation is an execution language description notation.

7. The method according to claim 6, wherein a description notation of the first description notation and the second description notation is one from the group comprising: an event-driven process chain notation, XML, BPEL-compliant XML, BPEL represented as graphical symbols, UML component diagram notation, value-added chain notation, BPMN, ERM, UML, IDEFX, BSC, XSD, DTD, SAP-SERM, OMT, SeDaM, PROMET, a program flow chart, and a process support map.

8. The method according to claim 6, wherein at least one of the first description notation and the second description notation includes one or more symbols that can be used to generate executable code.

9. The method according to claim 8, wherein the executable code is a BPEL-compliant XML code.

10. The method according to claim 6, wherein at least one of the first business information model and the second business information model is a business process model.

11. A method of providing navigation between business information models, comprising the steps of:
displaying a graphical representation of an object in a first business information model, the first business information model comprising a first description notation; and
providing an interface for navigating to display a second business information model, the second business information model comprising a second description notation, the second description notation not necessarily being different than the first description notation;
wherein the step of providing an interface includes providing the interface with the graphical representation of the object, and further wherein at least one of the first description notation and the second description notation is an execution language description notation.

12. The method according to claim 11, wherein a description notation of the first description notation and the second description notation is one from the group comprising: an event-driven process chain notation, XML, BPEL-compliant XML, BPEL represented as graphical symbols, UML component diagram notation, value-added chain notation, BPMN, ERM, UML, IDEFX, BSC, XSD, DTD, SAP-SERM, OMT, SeDaM, PROMET, a program flow chart, and a process support map.

13. The method according to claim 11, wherein the first description notation and the second description notation includes one or more symbols that can be used to generate executable code.

14. The method according to claim 13, wherein the executable code is a BPEL-compliant XML code.

15. The method according to claim 11, wherein the interface for navigating includes one or more of:
an expansion icon;
double clicking on a symbol;
shading, coloring, or otherwise altering the appearance of a symbol when the symbol can be used to navigate to a business information model; and
shading, coloring, or otherwise altering the appearance of the cursor when it is near a symbol that can be used to navigate to a business information model.

16. A system for modeling business information with integrated model data, the system comprising:
a processor,
a computer-readable medium containing instructions to configure the processor to perform a method comprising the steps of:
storing a first business information model, the first business information model being written in a first description notation;
storing a second business information model, the second business information model being written in a second description notation, the second description notation not necessarily being different from the first description notation; and
assigning the second business information model to an object, the object being represented by a symbol in the first business information model,
wherein at least one of the first description notation and the second description notation is an execution language description notation.

17. The system according to claim 16, wherein a description notation of the first description notation and the second description notation is one from the group comprising: an event-driven process chain notation, XML, BPEL-compliant XML, BPEL represented as graphical symbols, UML component diagram notation, value-added chain notation, BPMN, ERM, UML, IDEFX, BSC, XSD, DTD, SAP-SERM, OMT, SeDaM, PROMET, a program flow chart, and a process support map.

18. The system according to claim 16, wherein at least one of the first description notation and the second description notation includes one or more symbols that can be used to generate executable code.

19. The system according to claim 18, wherein the executable code is a BPEL-compliant XML code.

20. The system according to claim 16, wherein at least one of the first business information model and the second business information model is a business process model.

21. A system for providing navigation between one or more business information models, the system comprising:
a processor,
a computer-readable medium containing instructions to configure the processor to perform a method comprising the steps of:
displaying a graphical representation of an object in a first business information model, the first business information model being written in a first description notation; and
providing an interface for navigating to display a second business information model, the second model being written in a second description notation, the second description notation not necessarily being different than the first description notation;
wherein the step of providing an interface includes providing the interface with the graphical representation of the object, and further wherein at least one of the first description notation and the second description notation is an execution language description notation.

22. The system according to claim 21, wherein a description notation for the first description notation and the second description notation is one from the group comprising: an event-driven process chain notation, XML, BPEL-compliant XML, BPEL represented as graphical symbols, UML component diagram notation, value-added chain notation, BPMN, ERM, UML, IDEFx, BSC, XSD, DTD, SAP-SERM, OMT, SeDaM, PROMET, a program flow chart, and a process support map.

23. The system according to claim 21, wherein at least one of the first description notation and the second description notation includes one or more symbols that can be used to generate executable code.

24. The system according to claim 23, wherein the executable code is a BPEL-compliant XML code.

25. The system according to claim 21, wherein the interface for navigating includes one or more of:
an expansion icon;
double clicking on a symbol;
shading, coloring, or otherwise altering the appearance of a symbol when the symbol can be used to navigate to a business information model, and
shading, coloring, or otherwise altering the appearance of the cursor when it is near a symbol that can be used to navigate to a business information model.
